(19) United States
(12) Patent Application Publication
(10) Pub. No.: US 2024/0190535 A1
(43) Pub. Date: Jun. 13, 2024

(54) BOAT WITH BATTERY SUSPENSION SYSTEM

(71) Applicant: Polaris Industries Inc., Medina, MN (US)

(72) Inventors: Blair Donat, Osceola, WI (US); Erik Rogers, Bristol, IN (US); Benjamin D. Duke, Beaver Dam, WI (US)

(21) Appl. No.: 18/533,484

(22) Filed: Dec. 8, 2023

Related U.S. Application Data
(60) Provisional application No. 63/431,345, filed on Dec. 9, 2022.

(51) Int. Cl. B63B 11/00; B60L 50/60; B63B 1/12; B63B 35/38

(52) U.S. Cl. CPC B63B 11/00; B60L 50/66; B63B 1/121; B63B 35/38

(57) ABSTRACT

A pontoon boat having a battery stowage system for suspension of batteries in a pontoon. The system provides sufficient clearance between the batteries and a bottom interior of the pontoon to enable water that may enter the pontoon to pass under the batteries for discharge, for example with a bilge pump. The stowage system providing for positioning the batteries in a stowed position below the deck in a pontoon and for translating the batteries upwardly to a deck access opening. The system may provide ease of access during installation and service of the batteries while protecting the batteries from elements that may be present in the enclosure.

### RELATED CASES

This application claims priority to U.S. Provisional Application 63/431,345 filed Dec. 9, 2023, entitled BATTERY SUSPENSION AND POSITIONING SYSTEM, the contents of which are expressly incorporated by reference herein.

### BACKGROUND OF THE DISCLOSURE

There has been movement away from powering mobile systems as land vehicles and boats with fossil fuels and instead powering them with electrical energy. As such, the demand for more electrical power and attendant battery storage has increased, to the point that assemblies of batteries for mobile systems may weigh several hundred pounds.

### SUMMARY OF THE DISCLOSURE

Various embodiments of the disclosure are directed to systems that enable onboard stowage of batteries below deck and the passenger region in boats. The disclosed stowage systems are unobtrusive, utilizing space that is typically unoccupied and unused, for example within a boat hull or a pontoon or log of a pontoon boat. Batteries may be loaded into the stowage system through a single port or a plurality of ports and translated along a positioning axis for storage of multiple batteries. The translation of the batteries along the positioning axis also enables access of individual batteries for servicing without need for removing other of the batteries. In embodiments, the stowage system includes an upward translation system that allows translation from the stowed position below deck to an above deck access position or vice versa. In embodiments, the upward translation system may have a track system or an elevator system. In embodiments the battery stowage system also accommodates unwanted incursion of bilge liquids, such as instances where the batteries share a pontoon that also acts as a ski locker. Additional barriers between the intruding bilge liquid may be provided by a tray or trays upon which the batteries are stowed.

Structurally, various embodiments of a battery stowing system for a pontoon boat are disclosed, including a pontoon boat deck, a housing, a bracket contained within the housing, the bracket being configured to support a plurality of batteries, an access port defined through a wall of the housing for accessing the plurality of batteries, and a hatch for closure of the access port. The access port is sized for passage of at least one of the plurality of batteries therethrough. At least one tray may be supported by the bracket, the at least one tray being sized for receiving the plurality of batteries. In some embodiments, the at least one tray is configured to slide within the bracket. A telescopic rail slide may include a rail portion that slides within an anchor portion, the anchor portion being fixed to the bracket, the rail portion carrying the plurality of batteries. In some embodiments, a tray is supported by the rail portion, the tray dimensioned to receive at least one of the plurality of batteries. The housing may define a circular cross-section. In some embodiments, the bracket depends from an interior surface of the housing. The access port may include a perimeter structure that extends radially outward from the wall of the housing. The housing may include a discharge port for connection to a pump, for example a bilge pump.

In some embodiments, the housing is a hull of a boat with a plurality of hulls. In embodiments the hulls may be pontoons on a pontoon boat. The pontoon boat includes a platform or deck that may define a deck access opening for accessing the access port of the pontoon. In some embodiments, a panel covers the deck access opening.

Features and advantages of embodiments is that the center of gravity of batteries of a battery stowage system in a pontoon boat is positioned below the deck of the pontoon providing enhanced stability and keeping the batteries out of the way, whilst allowing ready access to the batteries through deck hatches. Features and advantages of embodiments allow battery packs with significant power capabilities to be carried by pontoon boats without negatively impacting the above deck utilization of pontoon furniture. Access panels at the deck surface may be unobtrusive and may be positioned below removable furniture or in the walkways of the pontoon boat deck. Battery stowage may be provided in each of three pontoons in a tritoon pontoon boat or in both pontoons of a pontoon boat with only two pontoons.

In embodiments, a pontoon boat has a plurality of pontoons supporting a deck, the deck having pontoon furniture mounted to the deck, and a battery stowage system mounted below the deck; the deck has a deck framework with deck frame members and bracketing extending from the deck frame members to the pontoons, the deck further has decking on a topside of the deck framework; the battery stowage system is positioned in a pontoon and has: a bracket contained within said pontoon for supporting a plurality of batteries and providing a clearance between the batteries and an interior bottom of the pontoon; an access port defined through a wall of said pontoon for accessing said plurality of batteries; and a deck access opening with a deck hatch for closure of said deck access opening; the battery stowage system provides translation of the plurality of batteries from a below deck stowed position to an above deck position at the deck access opening.

A boat has a deck with passenger area above the deck and a below deck region and a battery stowage system mounted below the deck; the battery stowage system is positioned in a housing and has a bracket contained within said housing for supporting a plurality of batteries spaced above a interior bottom of a hull; a deck access opening for accessing said plurality of batteries; the battery stowage system has at least one tray sized for holding one or more batteries, and the battery stowage system provides translation of the plurality of batteries from a below deck stowed position to an access position at or above the deck access opening.

A pontoon boat having a plurality of pontoons supporting a deck, the deck having pontoon furniture mounted to the deck, and a battery stowage system with a plurality of batteries mounted below the deck in one of the pontoons positioning the batteries at least 4 inches above an interior bottom of the pontoon; the deck has a deck framework with deck frame members and bracketing extending from the deck frame members to the pontoons, the deck further having decking on a topside of the deck framework with a deck access opening positioned above the battery stowage system, a hatch covering the deck access opening; and the battery stowage system further has a system for moving the plurality of batteries from a stowed position below the deck in the pontoon to an access position in or above the deck access opening.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

FIG. 1 is a perspective view of a pontoon boat with a battery stowage system according to embodiments.

FIG. 2 is a top plan view of a pontoon boat illustrating access deck hatches to a battery storage system.

FIG. 3 is a bottom view of the pontoon boat of FIG. 2 conceptually illustration locations of battery stowage systems.

FIG. 4 is a perspective view of the pontoon boat of FIG. 2 with furniture removed showing deck hatches.

FIG. 5A is a cross sectional view of the pontoon boat taken at line 5-5 of FIG. 2.

FIG. 5B is a perspective view of a single hull boat incorporating a battery stowage system according to an embodiment of the disclosure.

FIG. 6 is a partial cutaway view of a pontoon boat incorporating a battery stowage system according to an embodiment of the disclosure.

FIG. 7 is a sectional view of the battery stowage system utilized in FIG. 6 according to an embodiment of the disclosure.

FIG. 8 is a perspective view of a tray and track system according to an embodiment of the disclosure.

FIG. 9 is an elevational view of the tray and track system of FIG. 8 in operation according to an embodiment of the disclosure.

FIG. 10 is a perspective view of a tray and batteries loaded on an elevator assembly according to an embodiment of the disclosure.

FIG. 11 is a perspective view of a cable rack for routing wiring to the batteries according to an embodiment of the disclosure.

FIG. 12 is an elevational view of the elevator assembly of FIG. 10 in a retracted configuration according to an embodiment of the disclosure.

FIG. 13 is an elevational view of the elevator assembly of FIG. 10 in an extended configuration according to an embodiment of the disclosure.

### DETAILED DESCRIPTION OF THE FIGURES

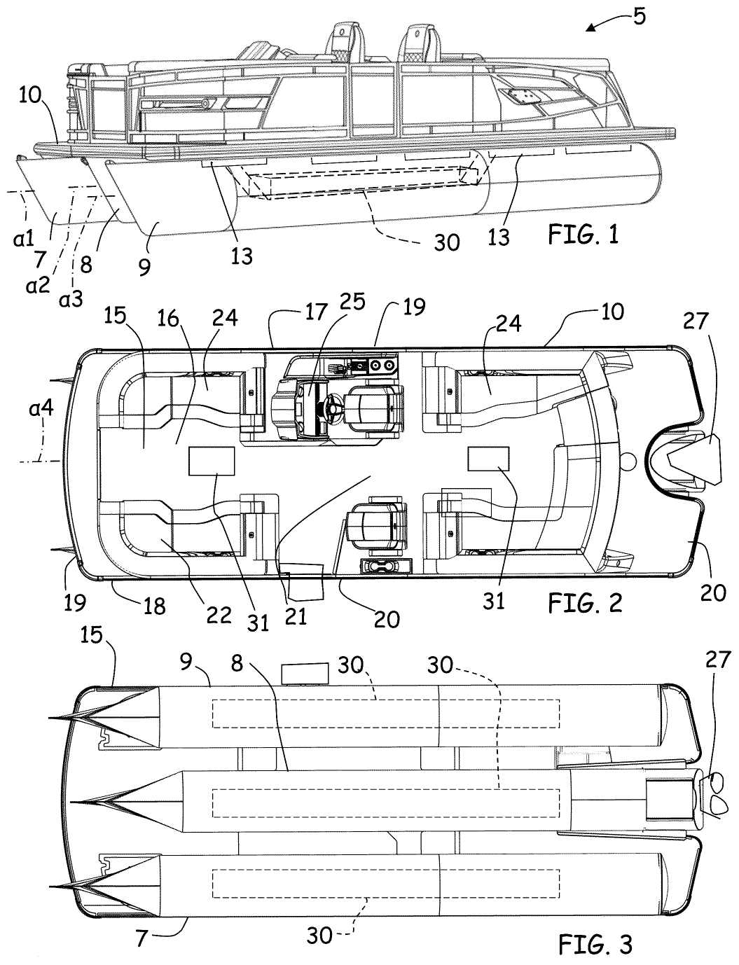

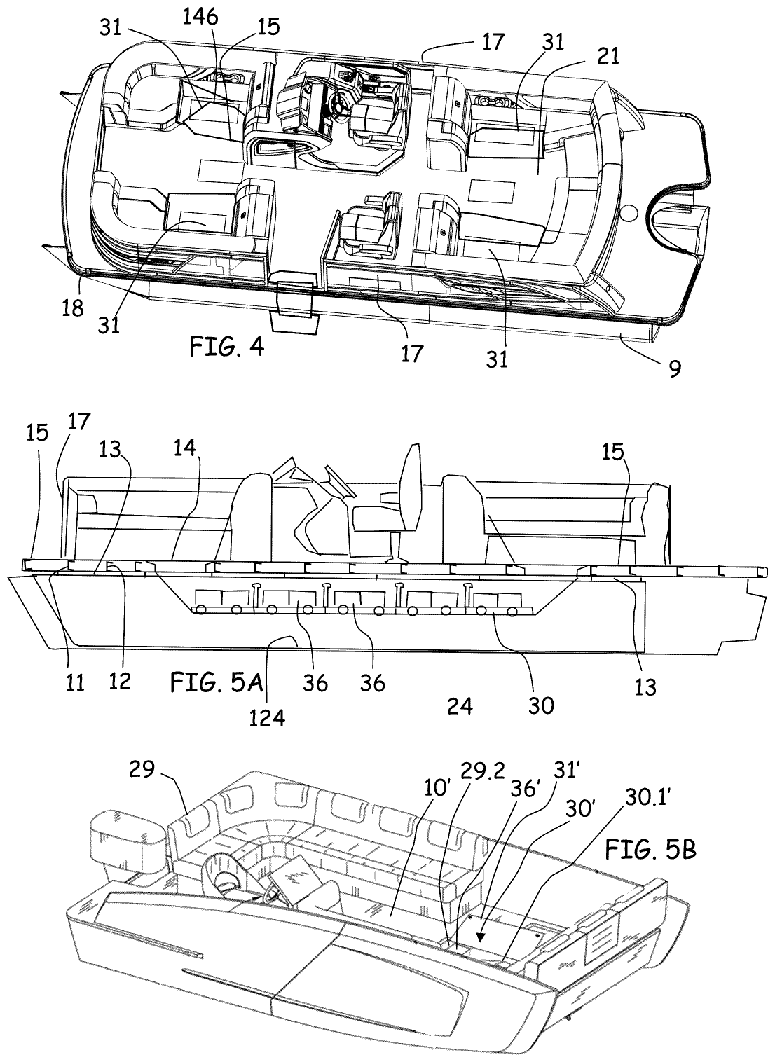

Referring to FIGS. 1-5A, in embodiments, a pontoon boat 5, generally includes a plurality of pontoons 7, 8, 9 supporting a deck 10. The pontoons having axis α1, α2, and α3 which are parallel to an elongate axis α4 of the pontoon boat. The deck 10 formed from of a deck framework 11, including framework cross members 12, configured as channels, and pontoon bracketing 13 connecting the framework cross members to the pontoons 7, 8, 9. The deck having deck paneling 14 defining an upper deck surface 15, with the framework defining the deck being generally open on the bottom side of the deck. Deck fencing 17 may extend around a periphery 18 of the deck 10 at the starboard and port sides 19, 20 and/or may be spaced from the periphery 18, such as illustrated at the bow 19 and stern 20. The upper deck surface 15 defining a passenger area 21 with pontoon boat furniture 22 such as seats 23, including removable seats 24, and an operator's counsel 25. A prime mover 27, shown configured as an outboard motor 27 may be electrically powered, or may be a hybrid having an internal combustion engine and one or more electrical motors. Batteries 36 for powering the motor 27 provided by battery stowage systems 30 below the deck 10, including a track 30.1, and may be in one or more of the pontoons as illustrated by the dashed lines in FIGS. 1 and 3 and shown in the cross section of FIG. 5. In embodiments, the stowage systems are accessible by hatches 31 in the deck 15 in the passenger walkways. Hatches 31 may be positioned in the exposed deck surface as shown best in FIG. 2, or may be positioned under removable or openable pontoon boat furniture as shown best in FIG. 4, where removable seats 24 illustrated in FIG. 2, have been moved from their normal seating positions exposing the hatches.

Referring to FIG. 5B, a single hulled boat 29 with a deck 10′ has a battery 36′ below the deck 10′ accessible by way of a stowage system 30′ including a track 30.1′ up into opening 29.2 and coverable by a hatch 31′. See U.S. Pat. Pub. 2022/0266951 incorporated by reference herein for all purposes, illustrating a single hull boat. Other configurations of boats, for example boats with more than one non-pontoon hulls may incorporate aspects of embodiments. See, for example, U.S. Pat. No. 11,459,064 incorporated by reference herein in its entirety for all purposes.

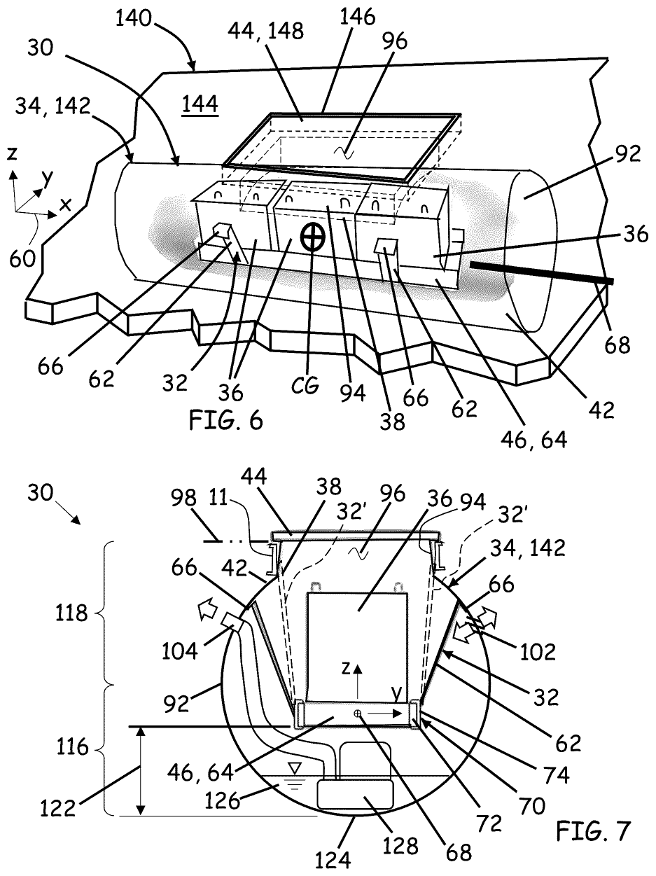

Referring to FIGS. 6 and 7, further details of embodiments of the battery stowage system 30 are depicted. The stowage system 30 includes a bracket or brackets 32 disposed within and supported by a housing 34, the brackets 32 being dimensioned to support one or more batteries 36. In embodiments as illustrated, the housing is one or more of the pontoons 7, 8, 9 of the pontoon boat 5 and the bracket extends to an interior surface of the pontoon. In embodiments, the bracket 32′ shown in dashed lines, may extend to and be supported by the pontoon deck framework 11. In embodiments, the housing may be a separate component, not a pontoon, below the pontoon boat deck. In other embodiments, the housing could be in a hull or integrated with the hull of a conventional boat. In embodiments, the housing could structure in a pontoon separate from the exterior structure of the pontoon. In some embodiments, the housing 34 includes an access port 38 that is defined through a wall 42 of the housing 34. A hatch 44 may provide closure of the access port 38. In some embodiments, one or more trays 46 are supported by the bracket 32 upon which the batteries 36 are mounted. Herein, individual batteries are referred to with the reference character 36 followed by a prime (′) suffix (i.e., “battery 36′”). The battery stowage system 30 may be referenced to a stowage coordinate system 60 that is in a fixed relationship with the housing 34 and of arbitrary origin. In embodiments, the x axis of the coordinate system is parallel to the axis of the pontoons α1, α2, α3 and the elongate axis α4 of the pontoon boat 5.

The batteries herein may be conventional lead acid 12 volt marine batteries which weigh in excess of 50 pounds and may weigh as much as 80 pounds each. The batteries may be other types of batteries, including higher voltage batteries, and may be, for example, lithium ion batteries and may weigh in excess of about 20 pounds and less than 40 pounds. In embodiments, each of the batteries may weigh between about 20 pounds and about 85 pounds. In embodiments, the entire plurality of batteries of a battery stowage system may weigh in excess of 100 pounds. In embodiments, the entire plurality of batteries of a battery stowage system may weigh in excess of 260 pounds. In embodiments, the entire plurality of batteries of a battery stowage system may weigh between about 160 pounds and 320 pounds. In embodiments, the plurality of batteries of a battery stowage system may include between 2 and 10 batteries. In embodiments, the plurality of batteries of a battery stowage system may include between 6 and 20 batteries. A pontoon boat may have one, two, three below deck battery stowage systems, for example one positioned in each pontoon of a pontoon boat.

In some embodiments, the bracket 32 includes struts 62 that extend from a frame 64. The struts 62 may include pads 66 that are oriented to locally conform to the wall 42 of the housing 34. Where the housing is a pontoon, the pontoon bracketing 13 may connect to the exterior surface of pontoon opposite the strut connection. The tray(s) 46 may be seated within the frame 64, or the tray(s) 46 may be integral with or constitute the frame 64. In some embodiments, the bracket 32 defines a positioning axis 68 along which the batteries 36 are disposed. The positioning axis 68 is generally parallel to the x-axis of the stowage coordinate system 60 and may be concentric therewith, in the context of the pontoon boat, the positioning axis is parallel to the axis of the three pontoons. The one or more batteries 36 may be a plurality arranged in a single row (depicted) or in a pair or plurality of rows. In some embodiments, the bracket 32 depends from the housing 34 (depicted); alternatively, the bracket 32 may extend upward from a lower portion of the housing 34. The struts 62 of the bracket may also support barrier plates (not depicted) that further isolated the tray(s) 46 and batteries 36 from elements within the lower section of the housing 34.

In some embodiments, telescopic rail assemblies 70 are attached to and supported by the bracket 32. The telescopic rail assemblies 70 may include a rail portion 72 and an anchor portion 74 that can be translated with respect to each other parallel to the positioning axis 68. In some embodiments, the telescopic rail assemblies 70 are mounted within the frame 64 of the bracket 32, for example with the anchor portion 74 affixed to the frame 64 and the rail portion 72 free to slide within the anchor portion 74. In some embodiments, the tray(s) 46 are affixed to and translates with the rail portions 72. The telescopic rail assemblies may include a locking mechanism (not depicted). Such telescopic rail assemblies 70 are commercially available, for example from Nadella, Inc. of Clearwater, Florida, U.S.A.

The housing 34 may include a body 92 that is hollow, such as a tube or cylinder. The access port 38 may include a perimeter structure 94 that extends outward from the wall 42 of the body 92 to surround an opening 96 defined by the access port 38. In some embodiments, the perimeter structure 94 may define a plane 98 over which the hatch 44 is seated (depicted). Alternatively, the hatch 44 may be arcuate or otherwise conform to the contour of the body 92. The housing 34 may be fitted with vents 102 and/or a discharge port 104. The opening 96 is dimensioned to enable passage of at least one battery 36′ therethrough, and may be dimensioned to enable access to two or three batteries 36 simultaneously.

In some embodiments, the housing 34 may be characterized as having a lower section 116 and an upper section 118. In some embodiments, a clearance 122 is defined between the frame 64 as well as the batteries and an interior bottom 124 of the housing that enables bilge liquid 126 such as water to accumulate and pass below the batteries 36. A discharge pump 128 may be in fluid communication with the bilge liquid 126 and the discharge port 104 for evacuation of the bilge liquid 126. In embodiments, the frame or track is positioned to provide about 4 inches or more of clearance between the interior bottom of the housing, such as a pontoon, and the batteries. In embodiments, the frame or track is positioned to provide about 8 inches or more of clearance between the interior bottom of the housing, such as a pontoon, and the batteries. In embodiments, the frame or track is positioned to provide between about 4 inches and about 16 inches of clearance between the interior bottom of the housing, such as a pontoon, and the batteries.

In some embodiments, the housing 34 is a log or pontoon 142 of a pontoon boat 140, the pontoon boat 140 including a deck 144 that is mounted to the pontoon 142. The deck 144 may define a deck access opening 146 through which the hatch 44 and access port 38 of the housing 34 can be accessed. In some embodiments, the deck access opening 146 is covered with a panel 148. The panel 148 and hatch 44 may be the same component (depicted).

Functionally, the pontoon boat 140 embodiment provides stowage of the batteries 36 in an unobtrusive location that is typically unoccupied and unused. The ability to translate the batteries 36 along the positioning axis 68 enables the access port 38 and associated deck access opening 146 to be modestly sized to accommodate only one battery 36′ at a time, and then translated away from the access port 38 to clear the access port for loading of additional batteries 36. Translation of the batteries 36 along the positioning axis also enables access of individual batteries 36′ for servicing without need for removing other of the batteries 36. Embodiments where the access port 38 and associated deck access opening 146 are large enough to access a plurality (e.g., two or three) batteries 36 simultaneously can provide for better access to individual batteries 36′ for servicing without need for removal. For embodiments where the bracket 32 depends from the upper section 118, no portion of the bracket 32 is in direct contact with the bilge liquid 126. The tray(s) 46 also provide an additional barrier between the bilge liquid 126 and the batteries 36 under normal operating and transporting conditions. The vents act to remove acidic vapors that may otherwise accumulate in the housing 34.

In operation, the one or more batteries 36 may be passed sequentially through the access port 38 for installation into the battery stowage system 30. Each battery 36′ may be connected electrically while accessible through the access port 38 and deck access opening 146. Upon completion of electrical hookup, the battery 36′ may be translated away from the opening 96 along the positioning axis 68, for example with the telescopic rail assemblies 70. The next battery 36′ may then be placed into the battery stowage system 30 and the process repeated. The batteries 36 may be locked in place on the bracket 32, for example by locking the telescopic rail assemblies 70. Similarly, if a particular one of the batteries 36′ needs to be serviced, the batteries 36 may be translated along the positioning axis 68 until the battery 36′ in need of service is accessible through the access port 38 and deck access opening 146. Translation of the batteries 36 along the positioning axis 68 enables the batteries 36 to be positioned to at a desired longitudinal center of gravity CG within the pontoon 142, or more generally for balancing the pontoon boat 140 as a whole.

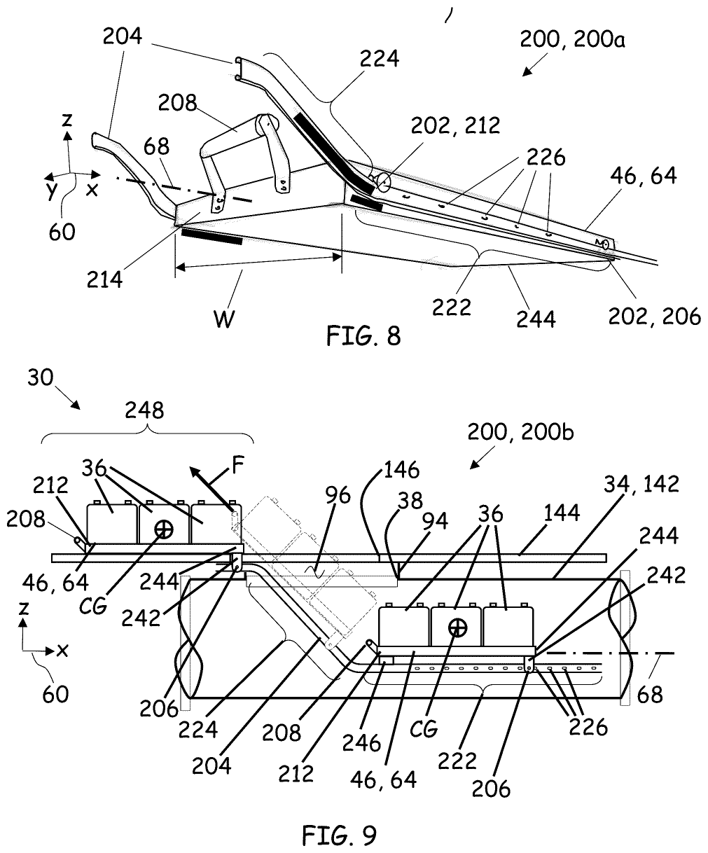

Referring to FIG. 8, a tray and track system 200a is depicted according to an embodiment of the disclosure. Track mounting fixtures 202 extend laterally beyond a width dimension W of the frame 64 to capture the tray 46 between parallel tracks 204. The track mounting fixtures 202 may include low friction components 206 that slidingly mate with the tracks 204, such as wheels (depicted), roller bearings, or slides. In some embodiments, the track mounting fixtures 202 include clips or hooks 212 that seat on top of the parallel tracks 204 when the tray and track system 200a is at rest. The frame 64 or tray 46 may include a grip handle 208 mounted to a first end 214 of the frame 64 or tray 46 for pulling the tray 46 along the tracks 204. The tracks 204 may define a stowage section 222 and an inclined section 224. In some embodiments, the stowage section 222 of the tracks 204 includes lock tabs 226. Herein, the tray and track system(s) are referred to generically or collectively by reference character 200, and individually or specifically by reference character 200 followed by a letter suffix (e.g., “tray and track system 200a”).

Referring to FIG. 9, a tray and track system 200b is depicted according to an embodiment of the disclosure. The tray and track system 200b may include some of the same components and attributes as the tray and track system 200a, some of which are depicted with same-labeled reference characters. Distinctions of the tray and track system 200b relative to the tray and track system 200a include track mounting fixtures 242 mounted proximate a second end 244 of the tray 46 that extend downward below the tray 46, the second end 244 being opposite the first end 212 of the tray 46. The track mounting fixtures 242 may also include the low friction components 206 akin to the track mounting fixtures 202 of the tray and track system 200a.

In some embodiments, the track mounting fixtures 242 extend laterally beyond the width dimension W of the frame 64 or tray 46. Alternatively, the track mounting fixtures 242 do not extend beyond the width dimension W of the frame 64 or tray 46, but instead are fully within the width dimension W. The tray and track system 200b may also include a registration block 246 that supports the first end 212 of the tray 46 when the tray and track system 200b is at rest on the stowage section 222 of the parallel tracks 204. The registration block 246 may be supported and dimensioned so that the track mounting fixtures 242 straddle the registration block 246 as the frame 64 and/or tray 46 pass thereover. A further distinction of the tray and track system 200b relative to the tray and track system 200a is that the first end 212 of the tray 46 and/or frame 64 rests on top of the deck 144, the parallel tracks 204 being secured to an underside of the deck 144 or a structure that supports the deck 144.

Operation of the tray and track system 200b is also depicted at FIG. 9. A force F may be exerted on the grip handle 208 when the tray 46 is at rest on the stowage section 222 of the parallel tracks 204, for example by manual grasping and pulling of the grip handle 208 by an operator. In some embodiments, the force F is vectored upward, thereby lifting the first end 212 of the tray 46 and/or frame 64 upwards and away from the registration block 246 and translating the track mounting fixtures 242 and the second end 244 of the tray 46 along the parallel tracks 204, as well as lifting and translating the first end 212 of the tray 46 over the inclined section 224 of the parallel tracks 204. The inclined section 224 may be situated to enable the tray 46 (with batteries 36) to be motivated through the access port 38 and deck access opening 146 by application of the force F. When fully extracted, the tray 46 may be placed on the deck 144. In some embodiments, the downward extension of the track mounting fixtures 242 enable the tray 46 and/or frame 64 to remain slidingly coupled to the parallel tracks 204 when the tray 46 is at rest on the deck 144.

Persons of ordinary skill in the relevant arts will recognize, in view of this disclosure, that the tray and track system 200a may be arranged mutatis mutandis for similar operation. That is, the upward vector of the force F can lift the clips 212 from the tops of the parallel tracks 204 for extraction of the tray 46 and/or frame 64. The parallel tracks 204 may include a servicing segment (not depicted) that extends from the inclined section 224 proximate the deck 144 and in a direction opposite the stowage section 222. The servicing segment may be configured for temporary attachment to the inclined section 224, for example during servicing. Other options include a permanently mounted servicing segment that is accessed by removal of the hatch 44.

Functionally, the tray and track systems 200 facilitate securing batteries 36 within the housing 34 as well as relocation of the batteries 36 to a work area 248 for servicing and maintenance. The depicted arrangement is amenable to manual operation, for example by kneeling on the deck 144 and reaching down to directly grasp the frame 64, tray 46, or grip handle 208 for application of the force F, or by coupling a tether (not depicted) thereto for pulling the batteries 36 into the work area 248. The lock tabs 226 may be configured to stop and secure the track mounting fixtures 202, 242 so that the longitudinal center of gravity CG is at the desired location within the housing 34/pontoon 142.

The downwardly extending track mounting fixtures 242 depicted at FIG. 9 enables the parallel tracks 204 to be routed beneath the tray 46 and/or frame 64 and within the width dimension W, thereby reducing dimensional requirements of the access port 38 and deck access opening 146, and attendant hatch 44 and panel 148. The registration block 246, when implemented, may include features (not depicted) that secure the tray 46 and/or frame 64 in place on the stowage section 222 of the parallel tracks 204 in addition to or instead of the lock tabs 226.

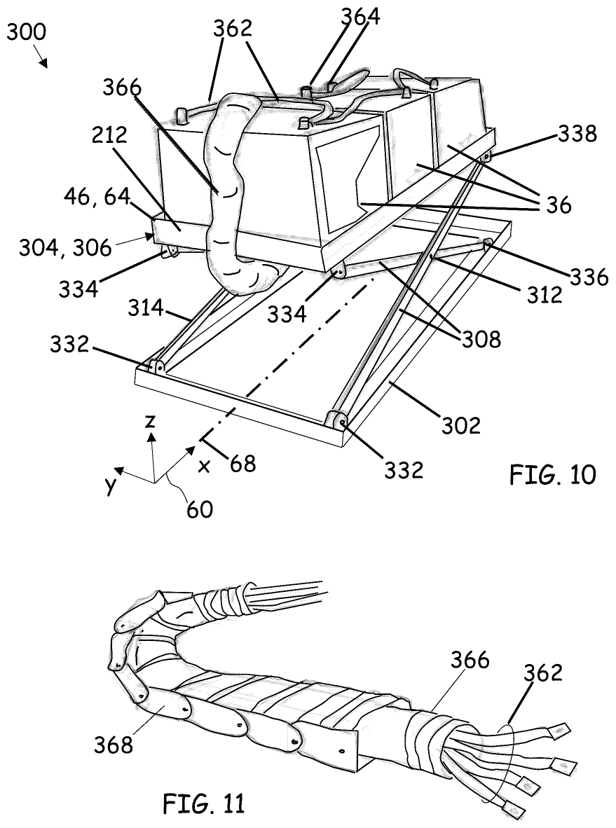

Referring to FIG. 10, an elevator assembly 300 for stowage and servicing of the batteries 36 is depicted according to an embodiment of the disclosure. The elevator assembly 300 may include some of the same components and attributes as the tray and track systems 200 and the stowage system 30 generally, some of which are depicted with same-labeled reference characters. The elevator assembly 300 includes a lift 304 that supports the tray 46 and/or frame 64 and batteries 36. The lift 304 may be, for example, a scissor assembly 306 (depicted). The elevator assembly 300 may include a base frame 306 that supports the frame 64 and/or tray 46 and scissor assembly 306. The base frame 302 may be supported by the bracket 32 extending to the housing or to the deck framework, as depicted in FIG. 13.

For the depicted embodiment, the scissor assembly 306 includes a pair of scissor struts 308 that are connected at a pivot 312. In some embodiments, the scissor assembly 306 includes a second pair of scissor struts 314 that mirror the scissor struts 308 about the positioning axis 68. The scissor assembly 306 may include lower and upper rotating couplings 332 and 334 and lower and upper translating couplings 336 and 338. The lower and upper rotating couplings 332 and 334 may be fixed relative to the x-axis of the stowage coordinate system 60, for example proximate the first end 212 of the tray 46 and/or frame 64. The lower rotating coupling 332 may be in a fixed vertical relationship with respect to the z-axis of the stowage coordinate system 60. In some embodiments, the translating lower coupling 336 is configured to translate along the base frame 302 and the upper coupling 338 is configured to translate along the frame 64 and/or tray 46, for example with the various track arrangements described in relation to the tray and track systems 200. The elevator assembly 300 may also include an actuator 342 (FIGS. 7 and 8) for powered operation.

Referring to FIG. 11 and again to FIG. 10, power cables 362 are depicted according to an embodiment of the disclosure. The power cables 362 are electrically coupled to terminals 364 on the batteries 36. The power cables 362 may be routed through a flexible conduit 366. In some embodiments, the power cables 362 and/or flexible conduit 366 are further supported by a cable rack 368. The power cables 362 may be routed under the tray 46 and/or frame 64 (FIG. 10) or along side the batteries 36 (FIGS. 7 and 8).

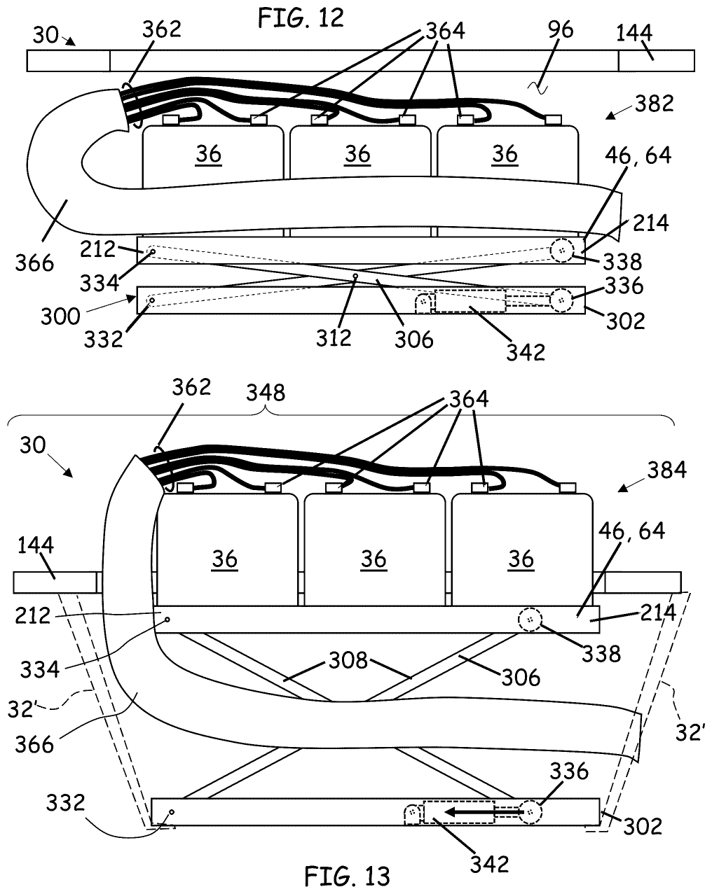

Referring to FIGS. 12 and 13, operation of the elevator assembly 300 is depicted according to an embodiment of the disclosure. In a retracted or stowage configuration 382, the frame 64 and/or tray 46 are vertically positioned close to the base frame 302 so that the batteries 36 and cabling 362 are underneath the deck 144. In an extended or servicing configuration 384, the frame 64 and/or tray 46 are vertically elevated relative to the retracted configuration 382 so that the cabling 362 and battery terminals 364 are proximate the elevation of the deck 144. The opening 96 and the deck 144 surrounding the opening 96 thus become the work area 248 for servicing and maintenance of the batteries 36.

To configure the elevator assembly 300 from the retracted configuration 382 to the extended configuration 384, the batteries 36 are elevated vertically upwards. For the scissor assembly 306 as depicted in FIGS. 12 and 13, the actuator 342 is activated to pull the translating couplings 336 and 338 toward the rotational couplings 332 and 334, which acts to elevate the frame 64 and/or tray 46, batteries 36, and battery terminals 364 vertically toward the opening 96.

To configure the elevator assembly 300 from the extended configuration 384 to the retracted configuration 382, the batteries 36 are lowered vertically downward. For the scissor assembly 306 as depicted in FIGS. 12 and 13, the actuator 342 is activated to push the translating couplings 336 and 338 away from the rotational couplings 332 and 334, which acts to elevate the frame 64 and/or tray 46, batteries 36, and battery terminals 364 vertically toward the opening 96.

The extended configuration 384 depicts the batteries 36 as projecting through the opening 96 so that the cabling 362 and battery terminals 364 are above the deck 144 and the tray 46 and/or frame 64 being below the deck 144. Such depiction is not limiting. That is, configurations are contemplated wherein the cabling 362 and battery terminals 364 are at or below the deck 144 but readily accessible for servicing. Configurations are also contemplated wherein the tray 46 and/or frame 64 are elevated to extend above the deck 144.

The actuator 342 as depicted in FIGS. 12 and 13 schematically resembles a hydraulic actuator. Such depiction is non-limiting. Other actuator types, such as pneumatic, electric motor, rack and pinion, worm gear, or chain and sprocket arrangements may be configured to motivate the scissor assembly 306 as described. Lift mechanisms alternative to the scissor assembly 306 are also contemplated, such as the above-mentioned drive systems arranged to drive the frame 64 and/or tray 46 vertically with respect to the base frame 302. Manual instead of powered motivation is also contemplated, for example with a chain and sprocket drive coupled to a crank handle. In view of this disclosure, adaptation of such drive mechanisms with or without a scissors assembly may be incorporated mutatis mutandis by persons of ordinary skill in the relevant arts.

Functionally, the elevator assembly 300 provides the battery stowage system 30 in a compact design. The flexible conduit 366 mechanically protects the power cables 362 from abrasion during operation of the elevator assembly 300, and may also provide a barrier between the power cables 362 and the bilge liquid 126. The cable rack 368 may assure the routing of the cables 362 and conduit 366, at least in the stowed configuration.

In some embodiments, the stowage system 30 is provided with instructions for use. The instructions are provided on a tangible, non-transitory medium, and may be physically included with the stowage system 30 such as on a printed document, compact disc, or flash drive. Non-limiting examples of a tangible, non-transitory medium include a paper document and computer-readable media including compact disc and magnetic storage devices (e.g., hard disk, flash drive, cartridge, floppy drive). The computer-readable media may be local or accessible over the internet. The instructions may be complete on a single medium or divided among two or more media. For example, some of the instructions may be written on a paper document that instruct the user to access one or more of the steps of the method over the internet, the internet-accessible steps being stored on a computer-readable medium or media. The instructions may embody the techniques and methods depicted or described herein using text, photos, videos, or a combination thereof to instruct and guide the user. The instructions may be in the form of written words, figures, photos, video presentations, or a combination thereof to instruct and guide the user.

The following clauses represent example subject matter described herein.

Clause 1. A pontoon boat comprising: a plurality of pontoons supporting a deck, the deck having pontoon furniture mounted to the deck, and a battery stowage system mounted below the deck; wherein the deck comprises a deck framework with deck frame members and bracketing extending from the deck frame members to the pontoons, the deck further comprising decking on a topside of the deck framework; wherein the battery stowage system is positioned in a pontoon and comprises: a bracket contained within said pontoon for supporting a plurality of batteries and providing a clearance between the batteries and an interior bottom of the pontoon; an access port defined through a wall of said pontoon for accessing said plurality of batteries; and a deck access opening with a deck hatch for closure of said deck access opening; wherein the battery stowage system provides translation of the plurality of batteries from a below deck stowed position to an above deck position at the deck access opening.

Clause 2. The pontoon boat of clause 1, wherein the battery stowage system comprises at least one tray supported by said bracket, said at least one tray being sized for receiving said plurality of batteries.

Clause 3. The pontoon boat of clause 2, wherein the battery stowage system further comprises a track system with which the at least one tray is slidingly or rollingly engaged.

Clause 4. The pontoon boat of clause 3, wherein the track system has a stowage section and an inclined section, the inclined section extending toward or to a deck access opening with the deck hatch.

Clause 5. The pontoon boat of clause 4, wherein the tray has a manual handle for pulling the tray up the inclined section.

Clause 6. The pontoon boat of clause 1, wherein the battery stowing system comprises an elevator that raises the plurality of batteries vertically from a below deck position upwardly to an access position.

Clause 7. The pontoon boat of clause 2, wherein the battery stowing system further comprises an elevator with a scissor mechanism for elevating and lowering the tray with the plurality of batteries.

Clause 8. The pontoon boat of clause 1, wherein a plurality of the plurality of pontoons each have a battery stowage system therein.

Clause 9. The pontoon boat of clause 3, wherein the battery stowage system comprises a plurality of trays serially arrangeable along the track system.

Clause 10. The pontoon boat of clause 9, wherein the battery stowage system further comprises the plurality of batteries with one or more batteries position in each of the plurality of trays, and wherein the batteries are connected with a plurality of cables extending through a flexible conduit.

Clause 11. The pontoon boat of clause 1, further comprising a bilge pump in the pontoon, and wherein the pontoon has a discharge port connected to the bilge pump.

Clause 12. The pontoon boat of clause 1, wherein the pontoon with the battery stowage system is vented.

Clause 13. A boat comprising: a deck with passenger area above the deck and a below deck region and a battery stowage system mounted below the deck; wherein the battery stowage system is positioned in a housing and comprises: a bracket contained within said housing for supporting a plurality of batteries spaced above a interior bottom of the housing; a deck access opening for accessing said plurality of batteries; wherein the battery stowage system comprises at least one tray sized for holding one or more batteries, and wherein the battery stowage system provides translation of the plurality of batteries from a below deck stowed position to an access position at or above the deck access opening.

Clause 14. The boat of clause 13, wherein the battery stowage system comprises a track system and the at least one tray is slidingly or rollingly engaged with the track system, the track system providing forward rearwardly translation of the at least one tray below the deck.

Clause 15. The boat of clause 14, wherein the track system has a stowage section and an inclined section, and wherein the inclined section extends towards the deck access opening.

Clause 16. The boat of clause 13, further comprising a hull, and wherein the housing is contained within the hull or is integrated with the hull.

Clause 17. The boat of clause 13, wherein the boat comprises two or three pontoons.

Clause 18. The boat of clause 17, wherein the housing is one of the two or three pontoons.

Clause 19. The boat of clause 17, wherein the boat has a starboard pontoon and a port pontoon, and each of the starboard and port pontoons have a battery stowage system.

Clause 20. A pontoon boat comprising: a plurality of pontoons supporting a deck, the deck having pontoon furniture mounted to the deck, and a battery stowage system with a plurality of batteries mounted below the deck in one of the pontoons positioning the batteries at least 4 inches above an interior bottom of the pontoon; wherein the deck comprises a deck framework with deck frame members and bracketing extending from the deck frame members to the pontoons, the deck further comprising decking on a topside of the deck framework with a deck access opening positioned above the battery stowage system, a hatch covering the deck access opening; and wherein the battery stowage system further comprises a system for moving the plurality of batteries from a stowed position below the deck in the pontoon to an access position in or above the deck access opening.

Clause 21. The pontoon boat of any of the above clauses, wherein the plurality of batteries is at least four.

Clause 22. The pontoon boat of any of the above clauses, wherein the system for moving the plurality of batteries from the stowed position to the access position comprises a track with one or more trays engaged therewith, the one or more trays for holding the batteries.

Clause 23. The pontoon boat of any of the above clauses wherein the system for moving the plurality of batteries from the stowed position to the access position comprises an elevator system with a powered scissor mechanism.

Clause 24. The pontoon boat of any of the above clauses, wherein the plurality of batteries weighs more than 100 pounds.

Each of the additional figures and methods disclosed herein can be used separately, or in conjunction with other features and methods, to provide improved devices and methods for making and using the same. Therefore, combinations of features and methods disclosed herein may not be necessary to practice the disclosure in its broadest sense and are instead disclosed merely to particularly describe representative and preferred embodiments.

Various modifications to the embodiments may be apparent to one of skill in the art upon reading this disclosure. For example, persons of ordinary skill in the relevant arts will recognize that the various features described for the different embodiments can be suitably combined, un-combined, and re-combined with other features, alone, or in different combinations. Likewise, the various features described above should all be regarded as example embodiments, rather than limitations to the scope or spirit of the disclosure.

Persons of ordinary skill in the relevant arts will recognize, in view of this disclosure, that various embodiments can comprise fewer features than illustrated in any individual embodiment described above. The embodiments described herein are not meant to be an exhaustive presentation of the ways in which the various features may be combined. Accordingly, the embodiments are not mutually exclusive combinations of features; rather, the claims can comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no patent claims included in the documents are incorporated by reference herein. Any incorporation by reference of documents above is yet further limited such that any definitions provided in the documents are not incorporated by reference herein unless expressly included herein.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art. Directional descriptors such as “lower”, “below”, “underneath”, and “underside” refer generally to the direction of a gravitational vector when the deck 144 is substantially horizontal. Directional descriptors such as “upper”, “top”, and “over” refer generally to the direction opposite the gravitational vector when the deck 144 is substantially horizontal.

For purposes of interpreting the claims, it is expressly intended that the provisions of 35 U.S.C. 112(f) are not to be invoked unless the specific terms “means for” or “step for” are recited in the respective claim.

What is claimed is:

1. A pontoon boat comprising:
a plurality of pontoons supporting a deck, the deck having pontoon furniture mounted to the deck, and a battery stowage system mounted below the deck;
wherein the deck comprises a deck framework with deck frame members and bracketing extending from the deck frame members to the pontoons, the deck further comprising decking on a topside of the deck framework;
wherein the battery stowage system is positioned in a pontoon and comprises:
a bracket contained within said pontoon for supporting a plurality of batteries and providing a clearance between the batteries and an interior bottom of the pontoon;
an access port defined through a wall of said pontoon for accessing said plurality of batteries; and
a deck access opening with a deck hatch for closure of said deck access opening;
wherein the battery stowage system provides translation of the plurality of batteries from a below deck stowed position to an above deck position at the deck access opening.

2. The pontoon boat of claim 1, wherein the battery stowage system comprises at least one tray supported by said bracket, said at least one tray being sized for receiving said plurality of batteries.

3. The pontoon boat of claim 2, wherein the battery stowage system further comprises a track system with which the at least one tray is slidingly or rollingly engaged.

4. The pontoon boat of claim 3, wherein the track system has a stowage section and an inclined section, the inclined section extending toward or to a deck access opening with the deck hatch.

5. The pontoon boat of claim 4, wherein the tray has a manual handle for pulling the tray up the inclined section.

6. The pontoon boat of claim 1, wherein the battery stowing system comprises an elevator that raises the plurality of batteries vertically from a below deck position upwardly to an access position.

7. The pontoon boat of claim 2, wherein the battery stowing system further comprises an elevator with a scissor mechanism for elevating and lowering the tray with the plurality of batteries.

8. The pontoon boat of claim 1, wherein a plurality of the plurality of pontoons each have a battery stowage system therein.

9. The pontoon boat of claim 3, wherein the battery stowage system comprises a plurality of trays serially arrangeable along the track system.

10. The pontoon boat of claim 9, wherein the battery stowage system further comprises the plurality of batteries with one or more batteries position in each of the plurality of trays, and wherein the batteries are connected with a plurality of cables extending through a flexible conduit.

11. The pontoon boat of claim 1, further comprising a bilge pump in the pontoon, and wherein the pontoon has a discharge port connected to the bilge pump.

12. The pontoon boat of claim 1, wherein the pontoon with the battery stowage system is vented.

13. A boat comprising:
a deck with passenger area above the deck and a below deck region and a battery stowage system mounted below the deck;
wherein the battery stowage system is positioned in a housing and comprises:
a bracket contained within said housing for supporting a plurality of batteries spaced above a interior bottom of the housing;
a deck access opening for accessing said plurality of batteries;
wherein the battery stowage system comprises at least one tray sized for holding one or more batteries, and wherein the battery stowage system provides translation of the plurality of batteries from a below deck stowed position to an access position at or above the deck access opening.

14. The boat of claim 13, wherein the battery stowage system comprises a track system and the at least one tray is slidingly or rollingly engaged with the track system, the track system providing forward rearwardly translation of the at least one tray below the deck.

15. The boat of claim 14, wherein the track system has a stowage section and an inclined section, and wherein the inclined section extends towards the deck access opening.

16. The boat of claim 13, further comprising a plurality of hulls, and wherein the housing is contained within one of the plurality of hulls or is integrated with the one of the plurality of hulls.

17. The boat of claim 16, wherein the boat comprises two or three pontoons.

18. The boat of claim 17, wherein the housing is one of the two or three pontoons.

19. The boat of claim 17, wherein the boat has a starboard pontoon and a port pontoon, and each of the starboard and port pontoons have a battery stowage system.

20. A pontoon boat comprising:
a plurality of pontoons supporting a deck, the deck having pontoon furniture mounted to the deck, and a battery stowage system with a plurality of batteries mounted below the deck in one of the pontoons positioning the batteries at least 4 inches above an interior bottom of the pontoon;
wherein the deck comprises a deck framework with deck frame members and bracketing extending from the deck frame members to the pontoons, the deck further comprising decking on a topside of the deck framework with a deck access opening positioned above the battery stowage system, a hatch covering the deck access opening; and
wherein the battery stowage system further comprises a system for moving the plurality of batteries from a stowed position below the deck in the pontoon to an access position in or above the deck access opening.
